(19) United States
(12) Patent Application Publication
(10) Pub. No.: US 2007/0170745 A1
(43) Pub. Date: Jul. 26, 2007

(54) Wheeled conveyance with two passenger support means

(76) Inventor: Mirka Seippel Siruckova, London (GB)

Correspondence Address: LERNER, DAVID, LITTENBERG,;KRUMHOLZ & MENTLIK, 600 SOUTH AVENUE WEST, WESTFIELD, NJ, 07090, US

(21) Appl. No.: 11/651,938

(22) Filed: Jan. 10, 2007

(30) Foreign Application Priority Data
Jan. 10, 2006 (GB) 06 00420.4

(51) Int. Cl. B62B 7/00

(52) U.S. Cl. 296/97.21

(57) ABSTRACT

A wheeled conveyance comprising a chassis adapted to be manually driven and supporting a first passenger support means and a second passenger support means, in which the chassis comprises one or more inclined struts, the outer ends of which support handle means for the wheeled conveyance, in which the first passenger support means is provided with a roof and in which the second passenger support means comprises a seat comprising said roof and a backing supported by the one or more inclined struts.

This invention relates to a wheeled conveyance with two passenger support means, for use particularly, but not exclusively, as a baby buggy with two seats, one mounted above the other.

Baby buggies are usually made for one child, however it is known to provide them with two or more seats. The seats can be next to one another, or one behind the other. Such buggies are usually used with twins, or children close in age, who both need to be conveyed.

Buggies with two seats are considerably larger than those with one seat, either in width or length, which makes them heavier, less manoeuvrable and harder to store or transport. Such buggies are also more expensive to manufacture and to purchase.

It is also known to provide buggies with means to convey two or more children of different ages and requirements. For example, some buggies can support a cot for an infant and a seat for a toddler. However, these are only suitable for an infant and toddler, and can not be used with two toddlers.

Further, it is known to provide a wheeled platform which bails behind a buggy, on which an older child can stand. However, these devices are not inherently safe for toddlers, as the user must hold onto the chassis of the buggy, and be strong on their feet or risk falling from the platform.

The present invention is intended to overcome some of the above problems.

Therefore, according to a first aspect of the present invention a wheeled conveyance comprises a chassis adapted to be manually driven and supporting a first passenger support means and a second passenger support means, in which the chassis comprises one or more inclined struts, the outer ends of which support handle means for the wheeled conveyance, in which the first passenger support means is provided with a roof and in which the second passenger support means comprises a seat comprising said roof and a backing supported by the one or more inclined struts.

Thus, the invention provides a less complex construction of conveyance, in which a single feature performs two functions, that of conveying the second passenger, while protecting the first from the elements.

It will be appreciated that the wheeled conveyance could be any manually drivable device, including a wheelchair or a pram. However, in a preferred construction the wheeled conveyance can be a baby buggy. Thus, the first passenger support means can be a first seat, and the second passenger support means can be a second seat

Baby buggies come in many guises, and have chassis of different shapes and constructions. However, most baby buggies have a generally triangular chassis with a pair of inclined struts extending all or some of the way from a handle means down to the front wheels, base struts supporting the wheels, and one or more upright or angled support struts extending from the base struts up to the inclined struts.

The invention works best if the buggy chassis comprises a pair of inclined struts, the outer ends of which support the handle means. As such the backing can be mounted between said pair of inclined struts.

The roof can be of a generally known construction and can be collapsible. Preferably the roof can comprise a substantially U-shaped leading strut member, the ends of which can be mounted in a hinged arrangement to said pair of included struts, or to the sides of a frame of said first seat. A flexible material can extend from said leading strut member to the pair of inclined struts or said frame, thereby to form the material of the roof. The roof can have an unfurled position in which the leading strut member is rotated forward until the material is taught, and a storage position in which the leading strut member is arranged substantially parallel with the pair of inclined struts or said frame.

Thus, the second seat can be folded away when the roof is arranged in the storage position.

The backing of the second seat can comprise a flexible material, which is pulled taught between the two inclined struts. Thus, if the buggy is collapsible such that the two inclined struts move together, the backing will collapse with the buggy.

Preferably the second seat can be provided with foot rests, which are mounted on said pair of inclined struts.

It will be appreciated that it is known to have a single seat baby buggy with a roof as described above. Therefore, the invention also includes a seat backing for retro-fitting to an existing buggy, in order to create the second seat.

Therefore, according to a second aspect of the present invention a backing adapted to be fitted to the chassis of a wheeled conveyance such that a wheeled conveyance as described above is formed, comprises a support and fixture means, in which the fixture means are adapted to be fitted to one or more inclined struts of said wheeled conveyance, above a roof thereof, such that a seat is formed with said roof as a base of said seat and said support as a back of said seat.

In a preferred construction the support can comprise a band of material with a first end and a second end, in which the fixture means can be provided at said first end and at said second end, in which the fixture means can be adapted to be fitted to a pair of inclined struts of said wheeled conveyance.

The invention can be performed in various ways, but two embodiments will now be described by way of example and with reference to the accompanying drawings, in which:

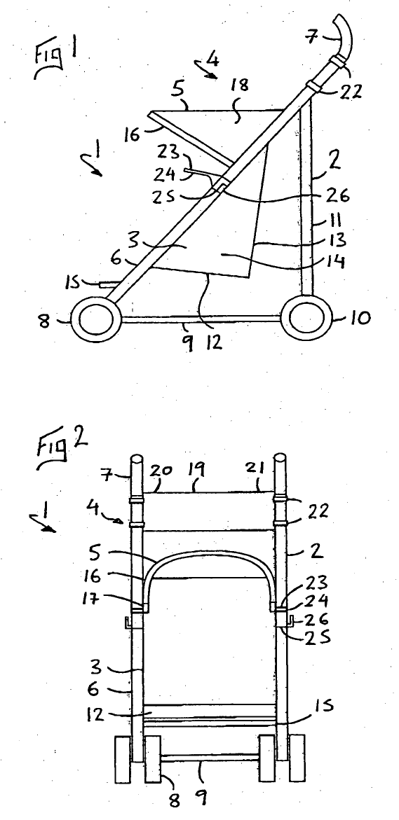

FIG. 1 is a side view of a wheeled conveyance according to the first aspect of the present invention;

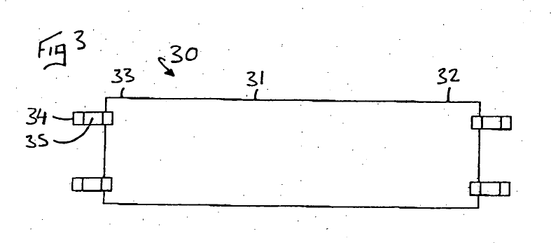

FIG. 2 is a front view of a wheeled conveyance according to the second aspect of the present invention; and,

FIG. 3 is a rear view of a seat backing according to the second aspect of the present invention.

As shown in FIG. 1 a wheeled conveyance in the form of baby buggy 1, comprises a chassis 2 adapted to be manually driven and supporting a first passenger support means in the form of first seat 3, and a second passenger support means in the form of second seat, generally designated 4. The chassis 2 comprises one or more inclined struts, in the form of a pair of included struts 6, the outer ends of which support handle means, in the form of handles 7, for the baby buggy 1. The first seat 3 is provided with a roof 5 and the second seat 4 comprises said roof 5 and a backing 19 supported by the one or more inclined struts 6.

The baby buggy 1 is of a conventional design, and the chassis 2 is generally triangular in shape. (For the purposes of explaining the present invention the chassis 2 is shown as comprising solid struts, however most buggies of this kind are collapsible, and are provided with multiple struts which are hinged together to facilitate the folding up of the chassis. Therefore the struts are provided with such folding mechanisms, however they are not shown or further described here as they are well known.)

The chassis 2 comprises said pair of inclined struts 6 which extend from handles 7 down to the front wheels 8, base struts 9 which support the front wheels 8 and the rear wheels 10, and upright struts 11 which extend from the base struts 9 up to the inclined struts 6.

The first seat 3 is a chair with a base 12, a back 13 and side walls 14, and it is mounted on the chassis 2 with the leading edges of the base 12 and side walls 14 parallel with the inclined struts 6. The first seat 3 is provided with a foot rest 15, and with collapsible roof 5.

The roof 5 comprises a rounded leading strut member 16, the ends of which are mounted on rotating hinges 17 supported by the inclined struts 6. The rotating hinges are provided with a spring loaded biasing mechanism (not shown) which urges the leading strut member 16 into the unfurled position shown in the Figures, when the leading strut member 16 is more than half unfurled. Likewise, the spring loaded biasing mechanism urges the leading strut member 16 into a stored position where it is parallel with the inclined struts 6, when the leading strut member 16 is less than half unfurled. Such mechanisms are well known and are not further described here.

Roofing material 18 extends from the leading strut member 16 to a corresponding base strut member (not visible) which is statically mounted between the inclined struts 6.

Thus, the roof 5 has an unfurled position as shown in the Figures in which the leading strut member 16 is rotated forward until the roofing material 18 is taught, and a storage position in which the leading strut member 16 is arranged substantially parallel with the base strut member (not visible).

Therefore, with regard to the chassis 2, the first seat 3 and the roof 5, the baby buggy 1 is of a generally known construction.

However, the baby buggy is provided with the second seat 4, which comprises the roof 5 and seat backing 19. The seat backing 19 comprises a band of flexible material which is mounted between the inclined struts 6, at a point above the roof 5. The seat backing 19 has a first end 20 and a second end 21, which are provided with mounting clips 22, which are a snap-fit on the inclined struts 6.

The second seat 4 is further provided with foot rests 23, which each comprise a platform 24 and a mounting clip 25, which is a snap-fit on the inclined struts 6. The mounting clips 25 are provided with hooks 26 for carrying luggage if desired.

In use the baby buggy 1 is used as normal, being collapsed for storage and transport, and unfurled for use. Likewise, the first seat 3 is used as normal, and the roof 5 can be unfurled or stored as desired.

However, if a second child is to be transported the second seat 4 can be used. The roof 5 is unfurled to the position shown in the Figures, and the second child is placed astride it. They sit back against the seat backing 19 and place their feet on the foot rests 23 to stabilise themselves. The seat backing 19 and the foot rests 23 can be positioned on the inclined struts as required for the child's size. The seat backing 19 should be arranged so the child's back rests against it, and the foot rests 23 should be arranged so the child's feet easily rest on them.

In use the roof material 18 may be compressed by the second child, however tile roof 5 does not fold up because of the spring loaded biasing mechanism in hinges 17.

It will be appreciated that if the second seat is not required, then the roof 5 can be folded up, and the seat backing 19 and foot rests 23 may be removed from the inclined struts 6. The seat backing 19 and the foot rests 23 can also be left in position on the inclined struts 16, as they do not hinder the normal use of the buggy 1, nor prevent it from being folded up.

It will also be appreciated that the second seat 4 can be provided on any existing buggy with a suitable roof. It is only required to fit the seat backing 19 and optionally the foot rests 23.

Therefore, the invention also includes a seat backing adapted to be fitted to the chassis of a baby buggy with which it is to be used, and such a seat backing is shown in FIG. 3.

Seat backing 30 in FIG. 3 is similar in construction to seat backing 19 as shown in FIGS. 1 and 2. It comprises a band of flexible material 31, with a first end 32 and a second end 33, each of which are provided with mounting clips 34. The clips 34 are disposed in slots (not visible) provided in the material 31 adjacent the first and the second ends 32 and 33. The clips are short cylinders provided with slots 35 in their rear. The clips 34 are constructed from a plastics material, and as such are provided with a resilient structure. In use they are attached to the chassis of a baby buggy in a snap-fit arrangement.

It will be appreciated that the clips 34 are adapted to fit onto chassis struts of a cylindrical shape, and of a certain diameter. The invention includes any shape of clip as required to fit onto any chassis.

The embodiment of the baby buggy described above can be altered without departing from the scope of claim 1. In particular, the components of the buggy can be fitted together in any suitable manner. For example the seat backing and the foot rests may be integral to the chassis, or may be fastened to it with any suitable means, for example with screws.

Further, some modem baby buggies comprise quite different chassis to chassis 2. For example, some comprise a collapsible chassis, onto which is mounted a removable seat which has its own frame, supporting its own roof. In other words the roof is not connected to the chassis, although it is generally disposed in the same place as roof 5 in use. Therefore in one alternate embodiment (not shown) the buggy comprises a chassis and a separate seat with its own roof.

While the majority of baby buggies have inclined struts much like those shown in FIGS. 1 and 2, some do not. However, in almost all cases there are inclined struts extending at least from the vicinity of the roof of the first seat, up to the handle. Therefore, the in another alternative embodiment (not shown) the chassis is of a complex structure comprising at least inclined struts extending from an area adjacent a roof of the first seat up to the handles.

Other buggies have a single inclined strut extending up to a handle, rather than a pair of parallel struts. The invention is still-possible with such buggies, but the seat backing must be adapted to mount to the single inclined strut, and must be self-supporting. Therefore in another alternative embodiment (not shown) the buggy comprises a chassis with a single inclined strut extending from above a roof of the first seat to the handle, and the seat backing comprises a self-supporting pad supported by said inclined strut.

In addition, the invention can be performed with other wheeled conveyances, for example a pram. Therefore, in one other alternative embodiment (not shown) the wheeled conveyance is a pram, the first passenger support means is a bed, and the second passenger support means is a seat, using the roof of the pram.

Thus a baby buggy is provided which provides seating for two children without the drawbacks of an increase in size, complexity and cost over a normal single seater buggy. Further, the second aspect of the invention provides components for fitting to an existing buggy in order to perform the first aspect of the invention.

1. A wheeled conveyance comprising a chassis adapted to be manually driven and supporting a first passenger support means and a second passenger support means, in which the chassis comprises one or more inclined struts, the outer ends of which support handle means for the wheeled conveyance, in which the first passenger support means is provided with a roof and in which the second passenger support means comprises a seat comprising said roof and a backing supported by the one or more inclined struts.

2. A wheeled conveyance as claimed in claim 1 in which the wheeled conveyance is a baby buggy, in which the first passenger support means comprises a first seat, and in which the second passenger support means comprises a second seat.

3. A wheeled conveyance as claimed in claim 2 in which the chassis comprises a pair of parallel inclined struts, and in which the backing is mounted between said pair of inclined struts.

4. A wheeled conveyance as claimed in claim 3 in which the second seat is provided with foot rests, which are mounted on said pair of inclined struts.

5. A wheeled conveyance as claimed in claims 3 or 4 in which the roof is collapsible.

6. A wheeled conveyance as claimed in claim 5 in which the roof comprises a substantially U-shaped leading strut member, the ends of which are mounted in a hinged arrangement to said pair of included struts of a frame of said first seat, and a flexible material extending from said leading strut member to the pair of inclined struts or said frame, in which the roof has an unfurled position in which the leading strut member is rotated forward until the material is taught, and a storage position in which the leading strut member is arranged substantially parallel with the pair of inclined struts or said frame.

7. A wheeled conveyance as claimed in any of claims 3-6 in which said backing comprises a flexible material, which is pulled taught between said pair of inclined struts.

8. A wheeled conveyance as claimed in claim 1 in which the wheeled conveyance is a pram and in which the first passenger support means comprises a bed.

9. A wheeled conveyance substantially as described herein and as shown in FIGS. 1 and 2.

10. A backing adapted to be fitted to the chassis of a wheeled conveyance such that a wheeled conveyance according to claim 1 is formed, comprising a support and fixture means, in which the fixture means are adapted to be fitted to one or more inclined struts of said wheeled conveyance, above a roof thereof, such that a seat is formed with said roof as a base of said seat and said support as a back of said seat.

11. A seat backing as claimed in claim 10 in which the support comprises a band of material with a first end and a second end, in which the fixture means are provided at said first end and at said second end, in which the future means are adapted to be fitted to a pair of inclined struts of said wheeled conveyance.

12. A seat backing substantially as described herein and as shown in FIG. 3.
